(19) United States
(12) Patent Application Publication
(10) Pub. No.: US 2021/0174288 A1
(43) Pub. Date: Jun. 10, 2021

(54) SYSTEM AND METHOD FOR PREDICTING PERFORMANCE FOR A CONTACT CENTER VIA MACHINE LEARNING

(71) Applicant: Genesys Telecommunications Laboratories, Inc., Daly City, CA (US)

(72) Inventors: Paul Michael Gvildys, Markham (CA); John Russell Christofolakos, Markham (CA); Liyuan Qiao, Markham (CA); Yizheng Yang, Markham (CA); Xiaoyang Guo, Markham (CA)

(73) Assignee: Genesys Telecommunications Laboratories, Inc.

(21) Appl. No.: 16/706,631

(22) Filed: Dec. 6, 2019

(51) Int. Cl. G06Q 10/06; G06Q 10/10; H04M 3/32; H04M 3/51; G06N 20/00

(52) U.S. Cl. CPC G06Q 10/06393; G06Q 10/06398; G06Q 10/06395; G06N 20/00; H04M 3/323; H04M 3/5175; G06Q 10/1053

(57) ABSTRACT

A system and method for predicting performance for a contact center via machine learning includes invoking, by a processor, an interaction between a contact center resource and an end user, and recording, by the processor, the interaction. The processor automatically analyzes the recorded interaction for identifying attributes associated with the interaction. The processor provides the identified attributes to a machine learning model which predicts a performance score based on the identified attributes. The performance score is compared against a threshold score, and a recommendation is output by the processor based on the comparing. The end user may be a candidate contact center agent considered for hiring, and the recommendation may be to hire the candidate or advance the candidate to a next step of an interview process.

### BACKGROUND

One problem faced by many customer contact centers is how to efficiently use resources of the contact center, including hardware and software resources, to process customer interactions. When a contact center agent is not proficient at his job, the resources are not used as efficiently as they could. For example, the resources may unnecessarily be used to transfer a current interaction to another agent who might be more proficient, to process repeated call-backs due to the customer's issue not being resolved the first time, and/or for a prolonged interaction with the customer due to the agent's lack of proficiency. The contact center often has no choice but to replace the underperforming agents with new agents. This contributes to the high turnover rate of agents at a contact center. As a result of the high turnover rate, contact centers engage in a seemingly endless task of looking and hiring new contact center agents.

Accordingly, what is desired is a system and method for predicting performance of candidate contact center agents prior to taking steps towards hiring such candidates.

### SUMMARY

In one exemplary embodiment, a method for predicting performance for a contact center via machine learning includes invoking, by a processor, an interaction between a contact center resource and an end user, and recording, by the processor, the interaction. The processor automatically analyzes the recorded interaction for identifying attributes associated with the interaction. The processor provides the identified attributes to a machine learning model, and predicts a performance score based on providing the identified attributes to the machine learning model. The performance score is compared against a threshold score, and a recommendation is output by the processor based on the comparing.

According to one embodiment, the interaction is a simulated call between the end user and a voice processor of the contact center. The voice processor may be configured with a script for conducting the simulated call.

According to one embodiment, the attributes that are identified by the processor include emotions of the end user during the interaction, adherence of the end user to a script invoked for the interaction, or clarity in speech of the end user during the interaction.

According to one embodiment, the automatically analyzing of the recorded interaction includes assigning a score to each of the identified attributes.

According to one embodiment, the performance score that is predicted by the processor is for predicting performance of the end user in meeting particular metrics for the contact center.

According to one embodiment, the processor further monitors contact center agents of the contact center, gathers performance scores of the monitored contact center agents, invokes a second interaction with the contact center agents, obtains attribute scores for the contact center agents based on the second interaction, correlates the attribute scores with the performance scores, and trains the machine learning model based on the correlation.

According to one embodiment, the processor also monitors a criteria of the contact center, and dynamically adjusts the threshold based on the monitored criteria.

According to one embodiment, the end user is a candidate contact center agent considered for hiring, and the recommendation is hiring the candidate or advancing the candidate to a next step of an interview process.

In one exemplary embodiment, a system for predicting performance for a contact center via machine learning includes a processor and memory. The memory has stored therein instructions that, when executed by the processor, cause the processor to: invoke an interaction between a contact center resource and an end user; record the interaction; automatically analyze the recorded interaction for identifying attributes associated with the interaction; provide the identified attributes to a machine learning model; predict a performance score based on providing the identified attributes to the machine learning model; compare the performance score against a threshold score; and output a recommendation based on the comparing.

As a person of skill in the art should recognize, predicting performance of candidate agents prior to hiring brings technical improvements to automatic call/interaction distribution systems typically used by customer contact centers. For example, the prediction helps to hire agents that are predicted to perform well after being employed. Agents who perform well allow more efficient use of contact center resources by, for example, allowing shorter interactions with customers, avoiding call transfers, avoiding repeat calls, and the like. Avoiding such tasks help avoid unnecessary tying up of resources such as processors, communication ports, queues, and the like.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of a system for predicting performance of candidate contact center agents according to one exemplary embodiment;

FIG. 2 is a conceptual diagram of a hiring machine learning model according to one exemplary embodiment;

FIG. 3 is a flow diagram of a process for training the hiring model of FIG. 2 according to one exemplary embodiment;

FIG. 4 is a flow diagram of a process for predicting performance of candidate contact center agents according to one exemplary embodiment;

FIG. 5 is a schematic block diagram of an automatic call/interaction distribution system for supporting a contact center in providing contact center services according to one exemplary embodiment;

FIG. 6A is a block diagram of a computing device according to one exemplary embodiment;

FIG. 6B is a block diagram of a computing device according to one exemplary embodiment;

FIG. 6C is a block diagram of a computing device according to one exemplary embodiment;

FIG. 6D is a block diagram of a computing device according to an embodiment of the present invention; and

FIG. 6E is a block diagram of a network environment including several computing devices according to one exemplary embodiment.

### DETAILED DESCRIPTION

In general terms, embodiments of the present invention are directed to a system and method for predicting performance of a candidate contact center agent prior to hiring the candidate. In one embodiment, the candidate is given a simulated call for handling. The call may simulate, for example, a scenario that the candidate would have to handle if hired to work at the contact center. In one embodiment, the call is recorded and transcribed for analysis. The analysis may entail, for example, automatically determining, based on text analytics, certain attributes, elements, features, or characteristics (collectively referred to as attributes) of the candidate when handling the call. The attributes may relate to, for example, emotion of the candidate during the simulation. The attributes may also relate to clarity in speech of the candidate, and/or adherence of the candidate to a script used for the simulation. In one embodiment, scores are provided for the detected attributes.

In one embodiment, the detected attributes and associated scores are provided as input features to a machine learning model. The machine learning model outputs a predicted performance score based on the received input features. The predicted performance score is compared against a threshold score, and a recommendation is made based on the comparison. The recommendation may be, for example, to hire (or not hire) the candidate, or advance (or not advance) the candidate to a next round of interviews.

In one embodiment, the machine learning model is trained with data of agents of the contact center for which actual performance scores have been computed. This helps avoid manually generating data for training the model. The automatically computed performance scores of contact center agents may be used as the training data. In addition, because an algorithm for computing the performance scores for a contact center is customized to the needs of the contact center, the model may also be customized to the unique needs of the contact center. For example, a contact center looking for energetic, young, and hip contact center agents (e.g. Nike contact center agents) may have the algorithm configured in such a way as to allow a higher performance score for agents that show characteristics that are associated with energetic, young, and hip agents. On the other hand, a contact center looking for more somber, calm, and collected agents (e.g. agents for a funeral home) may have the algorithm configured in such a way as to allow a higher performance scores for agents that show characteristics that are associated with somber, calm, and collected agents.

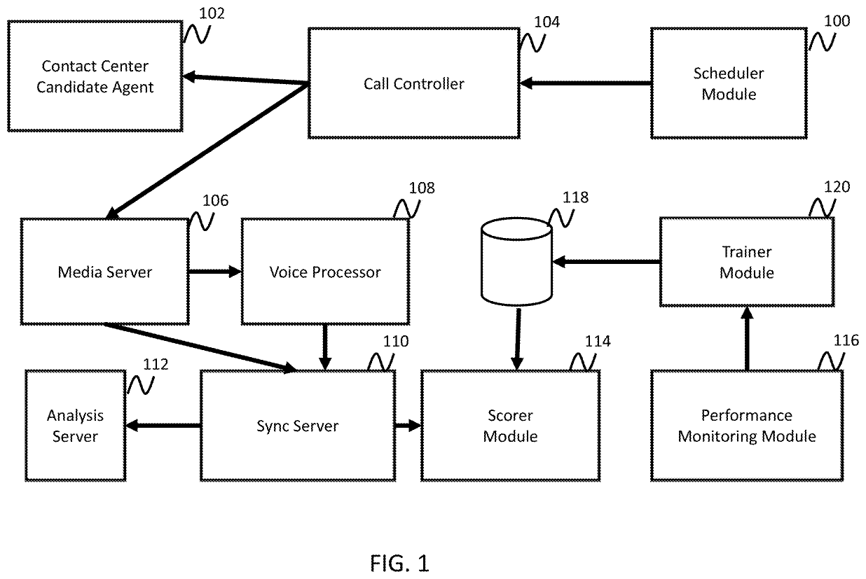

FIG. 1 is a block diagram of a system for predicting performance of candidate contact center agents according to one exemplary embodiment. The system may include a scheduler module 100 for scheduling and/or initiating a simulated call for a candidate contact center agent 102. The scheduler module 100 may provide a graphical user interface that an interviewer may access for scheduling the simulation. The graphical user interface may further provide a list of simulation scripts that the interviewer may select for the particular simulation.

At a designated time, the scheduler module 100 transmits a signal to a call controller 104 for initiating the simulated call to the candidate 102. In one embodiment, the call controller 104 is a session initiation protocol (SIP) server that transmits signaling messages for initiating a SIP call to the candidate 102. Once connected, the call controller 104 may route the call to a media server 106 configured with interactive voice response (IVR) capabilities. In one embodiment, the media server 106 interacts with the candidate 102 via voice prompts and responses as set out in the script that is used for the simulation. The media server 106 may further configured to record the call with the candidate 102.

A voice processor 108 is configured to take the recorded call from the media server 106 and associate the recording to the candidate 102. In one embodiment, the voice processor 108 retrieves metadata associated with the call recording (e.g. time, date, script ID, candidate ID (or dial number), and the like), and associates the retrieved metadata to information about the candidate (e.g. name), and provides the association to a synchronization server 110. The call recording and the associated data may also be stored in, for example, the data storage device 118.

In one embodiment, the synchronization server 110 is configured to provide the call recording to an analysis server 112 for conducting speech and sentiment analysis of the call. For example, the analysis may include analysis of the emotions of the candidate while handling the call, clarity of the speech of the candidate, and/or adherence by the candidate to the script that is used for the simulation. The analysis may be conducted via speech and sentiment analytics tools as is conventional in the art. For example, a third party product such as Vokaturi may be used for sentiment analysis. Google's speech-to-text software may be used for speech analytics and transcription.

In one embodiment, the synchronization server 110 forwards the analysis data to a scorer module 114 for predicting a performance score for the candidate. In one embodiment, the scorer module 114 is configured to train a machine learning model (hereinafter referred to as a hiring model), and use the trained model for making the prediction. The predictions may be based on a machine learning algorithm, such as one of various known regression or backpropagation algorithms.

In one embodiment, the data for training the model is provided by a performance monitoring module 116. Functionality of the performance monitoring module is described in detail in U.S. Pat. No. 8,589,215, the content of which is incorporated herein by reference. In general terms, the performance monitoring module 116 monitors agent performance in meeting certain contact center metrics, and determines objective performance measurements based on the monitoring. Such objective performance measurements may include, for example, a number of interactions that have been transferred to another agent per month, customer survey scores, number of repeat calls per month, and the like. In addition to objective performance measurements, the contact center may also consider certain subjective factors that may be important to the contact center, such as for example, enthusiasm, selling skills, teamwork, and the like. Scores for the subjective factors may be given, for example, by a supervisor who may evaluate the subjective factors after analyzing one or more interactions of the agent.

In one embodiment, the objective and subjective measurements are weighted and combined to generate an overall performance score for the agent. The performance evaluation of each agent of the contact center may be done on a periodic basis (e.g. every month or after X number of interactions), and stored in a data storage device 118 in association with the agent until a next evaluation is performed.

If an agent's performance is deemed to be below a threshold, a trainer module 120 may be invoked for scheduling appropriate training sessions for the agent. In one embodiment, in order to generate training data that correlates an agent's performance score with certain attributes of the agent that may be expressed when handling a call, the agent is provided the same simulated call as the candidate 102 for handling. The simulated call with the agent is analyzed for detecting attributes such as sentiment, clarity, and adherence, and scores for the detected attributes are correlated to the agent's performance score that is currently associated with the agent at the time of the simulated call. In some embodiments, one or more of the real calls handled by the agent may be analyzed by the analysis server 112 for determining sentiment, clarity, and adherence. In this manner, the training data is generated automatically and based on performance metrics already identified by the contact center in generating performance scores for the agents.

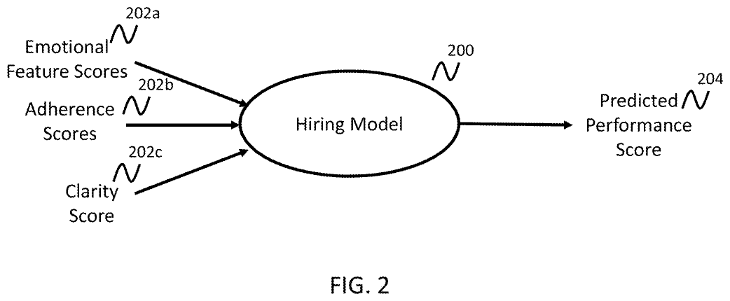

FIG. 2 is a conceptual diagram of a hiring machine learning model 200 according to one exemplary embodiment. The model may be, for example, a statistical model that is trained based on training data provided to the model. In one embodiment, the training data includes input features taking the form of attributes 202a-202c (collectively referenced as 202) of agents when handling, for example, a simulated call. Such attributes may include, without limitation, emotional feature scores 202a, adherence scores 202b, and clarity scores 202c. The input features are mapped/correlated to particular target values. In one embodiment, the target values are agent performance scores 204 provided by the performance monitoring module 116. In one embodiment, the model learns the correlation between the input features and the target via, for example a linear or polynomial regression. In this regard, the model 200 may include a set of weights for each of the input features of the regression model.

In some embodiments, the model may correspond to a neural network or a deep neural network (a deep neural network being a neural network that has more than one hidden layer, for use with deep learning techniques), and the training of the neural network may involve using the training data and an algorithm, such as a back propagation algorithm. The neural network may further include a set of weights for connections between the neurons of a trained neural network.

Once the model is trained, the model may be used to receive the attributes 202 of the contact center candidate that is being interviewed, including, for example, the candidate's emotional feature scores 202a, adherence scores 202b, clarity scores 202c, and the like, to output the corresponding predicted performance score 204.

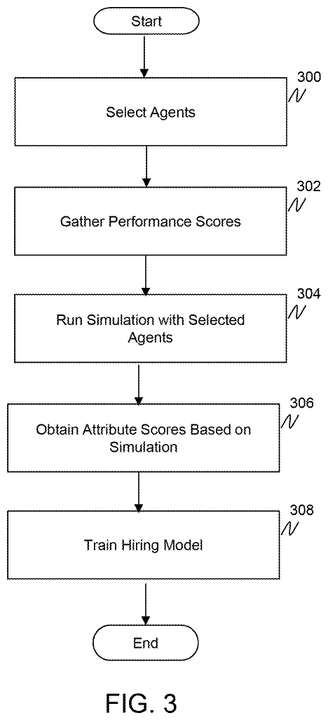

FIG. 3 is a flow diagram of a process for training the hiring model 200 according to one embodiment.

In act 300, the scorer module 114 (or the scheduler module 100) selects agents of the contact center for training the hiring model 200. All or a subset of the agents may be selected for this purpose.

In act 302, the scorer module 114 gathers performance scores of the selected agents from the data storage device 118.

In act 304, the scheduler module 100 runs a simulated call with the selected contact center agents. In this regard, the scheduler module 100 invokes the call controller 104 for initiating the simulated call with the selected contact center agents. One or more different simulated calls may be selected for being handled by the selected contact center agents at different times. At least one of the simulated calls is the simulated call that is provided to the candidate contact center agent 102 during an interview process.

In act 306, the scorer module 114 obtains scores of the attributes 202 that are monitored for the contact center agents while handling the simulated call. In this regard, the simulated call may be recorded and handed to the analysis server 112 for determining the scores. The scores that may be obtained include, for example, the emotional feature scores 202a, adherence scores 202b, and clarity scores 202c that are used to train the hiring model 200.

In act 308, the scorer module 114 maps the scores of the attributes to the performance values of the selected agents.

In act 310, the hiring model 200 is trained based on the mapping of the attribute scores to the performance values for each of the selected agents.

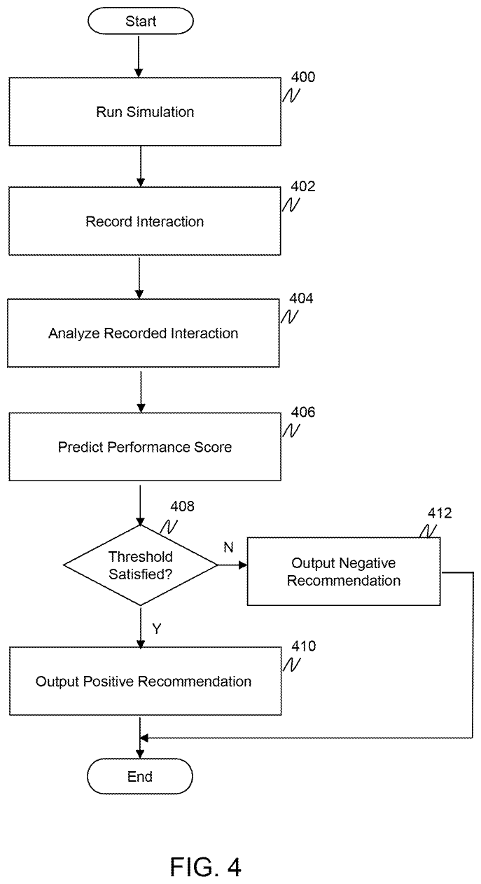

FIG. 4 is a flow diagram of a process for predicting performance of candidate contact center agents according to one exemplary embodiment. In act 400, the scheduler module 100 runs a simulation of a telephony call with the candidate agent 102. In this regard, a telephony connection is established between a communication device of the candidate agent 102 and the media server 106. The media server 106 may be configured to follow a dialogue script corresponding to the simulation to generate outputs that are responsive to the candidate's utterances. Although a telephony call is used as an example, a person of skill in the art should recognize that other types of interactions via other types of communication media may be used instead of a telephony call. For example, the simulation may be a text based chat, and may involve other servers such as an interaction server and/or chat server.

In the event of a telephony simulation, the interaction between the candidate agent 102 and the media server 106 is recorded in act 402. The recorded interaction may be saved in, for example, the data storage device 118, along with metadata for the simulated call, and information about the candidate 102.

In act 404, the analysis server 112 analyzes the recorded interaction for conducting, for example, speech and sentiment analysis of the call, and assigning scores to the various input features to be fed to the hiring model 200. Speech analytics may entail transcribing the audio speech into text, and parsing the text for determining the presence of keywords. The keywords may be obtained from the script that is used for the simulation. In one embodiment, an adherence score 202b is provided based on the number and timing of the keywords. For example, the analysis server 112 may parse the transcribed conversation for the occurrence of the phrase “thank you” at the end of the call, to make sure that the candidate agent has expressed his gratitude to the simulated customer at the end of the call.

In one embodiment, speech analytics may also entail determining clarity of speech by the candidate agent 102 during the call, and assigning a clarity score 202c in response to the determination. The clarity score may be based on a confidence level of the speech recognition. The less clear the utterance by the candidate agent, the harder it is for the analysis server to perform the speech analytics, resulting in a lower confidence score (and lower clarity score 202c) for the transcription.

Sentiment analysis may entail, for example, determining emotions of the candidate agent while handling the call simulation. The emotions that are detected may include, but are not limited to fear, sadness, anger, happiness, and the like, and may be deduced based on, for example, the words spoken by the candidate, tone, how fast/slow the words are being uttered, and/or the like. A separate emotion score may be assigned to each of the various emotions detected during the analysis, and fed to the hiring model 200 as the emotional feature scores 202a.

In act 406, the hiring model 200 takes the scores of the various attributes 202 detected for the candidate agent, and generates a predicted performance score 204 for the candidate agent 102. In one embodiment, the predicted performance score is for predicting performance of the candidate agent in meeting particular metrics of the contact center. Such metrics may relate to, for example, call transfers, repeat calls, number of interactions handled, enthusiasm, teamwork, and the like.

In act 408, the predicted performance score is compared against a threshold value.

If the performance score satisfies the threshold value (e.g. is equal or higher to the threshold value), the scorer module 114 outputs a positive recommendation in act 410. The positive recommendation may be, for example, a recommendation to hire the candidate agent 102, or advance the candidate to a next round of interviews. If moving the candidate to a next round, the contact center may automatically schedule the candidate for the up-coming interviews. The contact center may also automatically generate a congratulatory message for delivery to the candidate agent 102.

If, however, the performance score does not satisfy the threshold value (e.g. is lower than the threshold value), the scorer module 114 outputs a negative recommendation in act 412. The negative recommendation may be, for example, a recommendation to not hire the candidate agent 102.

In one embodiment, the threshold that is used for the hiring process is re-evaluated and modified, as necessary, on a periodic basis. The threshold value, thus, is not static, but may be dynamically adjusted based on the needs of the contact center.

In one embodiment, the threshold may be adjusted to be a particular value, or it may be left unset. In the latter case, instead of looking for candidates satisfying a particular threshold, the contact center may select a set top percent of the candidates, and move them to a next round of interviews. For example, the predicted performance scores of the candidate agents may be ranked in descending order, and a top X % (e.g. 25%) of the scores may be selected for being recommended for the next round.

In one embodiment, the threshold is selected based on a correlation of performance scores of actual agents of the contact center, and particular events associated with those agents. The particular event may be, for example, termination of employment. In this regard, the scorer module 114 may identify performance scores of agents whose employment was terminated, and set the threshold based on such identification. The threshold may be set, for example, to be an average of the performance scores of the terminated agents, or set to be the maximum performance score of the terminated agents.

The threshold may also be periodically adjusted based on hiring needs of the contact center. For example, during a product launch or at certain times of the year, the contact center may have to increase its contact center staff. In this case, the threshold may be set based on staffing need, past speed of hiring, and time left until the staffing is needed. In one embodiment, the threshold may also depend on the pool of applicants that have applied for the job. Once the initial threshold is set, the hiring speed of contact center agents may be monitored to determine if enough agents are being hired. As time passes, if not enough agents have been hired, the threshold may be lowered to increase the hiring speed.

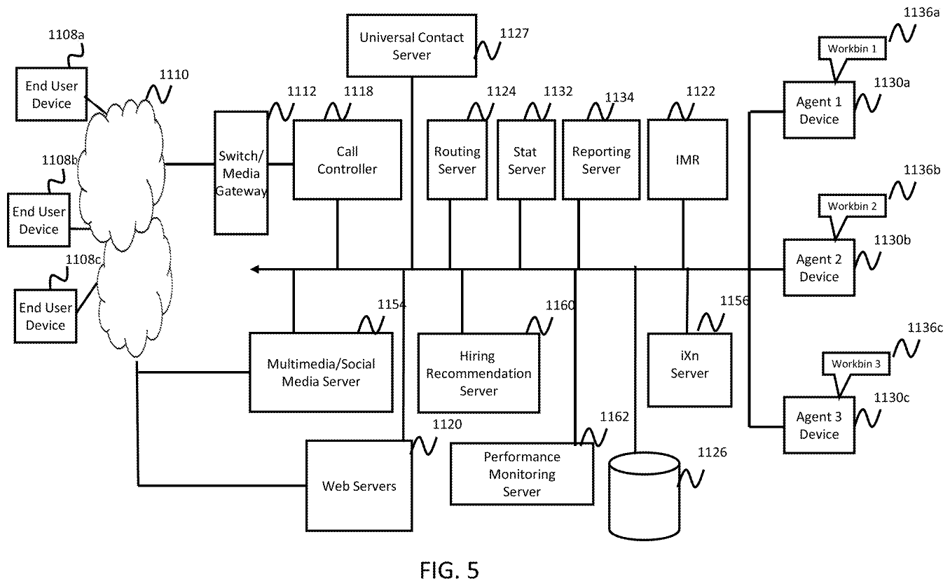

FIG. 5 is a schematic block diagram of an automatic call/interaction distribution system for supporting a contact center in providing contact center services according to one exemplary embodiment. The contact center may be an in-house facility to the particular trusted brand 18 to perform the functions of sales and service relative to the products and services available through the brand. In another aspect, the contact center may be operated by a third-party service provider. According to some embodiments, the contact center may operate as a hybrid system in which some components of the contact center system are hosted at the contact center premise and other components are hosted remotely (e.g., in a cloud-based environment). The contact center may be deployed in equipment dedicated to the brand or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

According to one example embodiment, the contact center system 1160 manages resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as the customers 12) desiring to receive services from the contact center may initiate inbound communications (e.g., telephony calls) to the contact center via their end user devices 1108a-1108c (collectively referenced as 1108). Each of the end user devices 1108 may be a communication device conventional in the art, such as, for example, a telephone, wireless phone, smart phone, personal computer, electronic tablet, and/or the like. Users operating the end user devices 1108 may initiate, manage, and respond to telephone calls, emails, chats, text messaging, web-browsing sessions, and other multi-media transactions.

Inbound and outbound communications from and to the end user devices 1108 may traverse a telephone, cellular, and/or data communication network 1110 depending on the type of device that is being used. For example, the communications network 1110 may include a private or public switched telephone network (PSTN), local area network (LAN), private wide area network (WAN), and/or public wide area network such as, for example, the Internet. The communications network 1110 may also include a wireless carrier network including a code division multiple access (CDMA) network, global system for mobile communications (GSM) network, or any wireless network/technology conventional in the art, including but to limited to 3G, 4G, 5G, LTE, and the like.

According to one example embodiment, the contact center system includes a switch/media gateway 1112 coupled to the communications network 1110 for receiving and transmitting telephony calls between the customers 12 and the contact center. The switch/media gateway 1112 may include a telephony switch or communication switch configured to function as a central switch for agent level routing within the center. The switch may be a hardware switching system or a soft switch implemented via software. For example, the switch 1112 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

According to one exemplary embodiment of the invention, the switch is coupled to a call controller 1118 which may, for example, serve as an adapter or interface between the switch and the remainder of the routing, monitoring, and other communication-handling components of the contact center.

The call controller 1118 (which may be similar to the call controller 104 of FIG. 1) may be configured to process PSTN calls, VoIP calls, and the like. For example, the call controller 1118 may be configured with computer-telephony integration (CTI) software for interfacing with the switch/media gateway and contact center equipment. In one embodiment, the call controller 1118 may include a session initiation protocol (SIP) server for processing SIP calls. According to some exemplary embodiments, the call controller 1118 may, for example, extract data about the customer interaction such as the caller's telephone number, often known as the automatic number identification (ANI) number, or the customer's internet protocol (IP) address, or email address, and communicate with other contact center components in processing the interaction.

According to one exemplary embodiment of the invention, the system further includes an interactive media response (IMR) server 1122, which may also be referred to as a self-help system, virtual assistant, or the like. In one embodiment, the IMR server 1122 takes the form of the media server 106 and/or voice processor 108 of FIG. 1. The IMR server 1122 may also be similar to an interactive voice response (IVR) server, except that the IMR server 1122 is not restricted to voice, but may cover a variety of media channels including voice. Taking voice as an example, however, the IMR server 1122 may be configured with an IMR script for querying customers on their needs. For example, a contact center for a bank may tell customers, via the IMR script, to “press 1” if they wish to get an account balance. If this is the case, through continued interaction with the IMR server 1122, customers may complete service without needing to speak with an agent. The IMR server 1122 may also ask an open ended question such as, for example, “How can I help you?” and the customer may speak or otherwise enter a reason for contacting the contact center. The customer's response may then be used by a routing server 1124 to route the call or communication to an appropriate contact center resource.

In one embodiment, the IMR script invoked by the IMR server 1122 may take the form of a script for a simulated call if the IMR server 1122 is being invoked during an interview of the candidate agent 102, or if being invoked for gathering feature inputs for training the hiring model 200.

If the communication is to be routed to an agent, the call controller 1118 interacts with the routing server (also referred to as an orchestration server) 1124 to find an appropriate agent for processing the interaction. The selection of an appropriate agent for routing an inbound interaction may be based, for example, on a routing strategy employed by the routing server 1124, and further based on information about agent availability, skills, and other routing parameters provided, for example, by a statistics server 1132.

In some embodiments, the routing server 1124 may query a customer database, which stores information about existing clients, such as contact information, loyalty information, service level agreement (SLA) requirements, nature of previous customer contacts and actions taken by contact center to resolve any customer issues, and the like. The database may be, for example, Cassandra or any NoSQL database, and may be stored in a mass storage device 1126 (which may be similar to the data storage device 118 of FIG. 1). The database may also be a SQL database and may be managed by any database management system such as, for example, Oracle, IBM DB2, Microsoft SQL server, Microsoft Access, PostgreSQL, MySQL, FoxPro, and SQLite. The routing server 1124 may query the customer information from the customer database via an ANI or any other information collected by the IMR server 1122.

Once an appropriate agent is identified as being available to handle a communication, a connection may be made between the customer and an agent device 1130a-1130c (collectively referenced as 1130) of the identified agent. Collected information about the customer and/or the customer's historical information may also be provided to the agent device for aiding the agent in better servicing the communication. In this regard, each agent device 1130 may include a telephone adapted for regular telephone calls, VoIP calls, and the like. The agent device 1130 may also include a computer for communicating with one or more servers of the contact center and performing data processing associated with contact center operations, and for interfacing with customers via voice and other multimedia communication mechanisms.

The contact center system may also include a multimedia/social media server 1154 for engaging in media interactions other than voice interactions with the end user devices 1108 and/or web servers 1120. The media interactions may be related, for example, to email, vmail (voice mail through email), chat, video, text-messaging, web, social media, co-browsing, and the like. In this regard, the multimedia/social media server 1154 may take the form of any IP router/processor conventional in the art with specialized hardware and/or software for receiving, processing, and forwarding multi-media events. For example, the multimedia/social media server 1154 may include a chat server for processing text-based chat conversations, email server or processing emails, SMS server for processing text-messages, and the like.

The web servers 1120 may include, for example, social interaction site hosts for a variety of known social interaction sites to which an end user may subscribe, such as, for example, Facebook, Twitter, and the like. In this regard, although in the embodiment of FIG. 5 the web servers 1120 are depicted as being part of the contact center system, the web servers may also be provided by third parties and/or maintained outside of the contact center premise. The web servers may also provide web pages for the enterprise that is being supported by the contact center. End users may browse the web pages and get information about the enterprise's products and services, and/or purchase/reserve such products and services. The web pages may also provide a mechanism for contacting the contact center, via, for example, web chat, voice call, email, web real time communication (WebRTC), or the like.

According to one exemplary embodiment, in addition to real-time interactions, deferrable (also referred to as back-office or offline) interactions/activities may also be routed to the contact center agents. Such deferrable activities may include, for example, responding to emails, responding to letters, attending training seminars, or any other activity that does not entail real time communication with a customer. In this regard, an interaction (iXn) server 1156 interacts with the routing server 1124 for selecting an appropriate agent to handle the activity. Once assigned to an agent, an activity may be pushed to the agent, or may appear in the agent's workbin 1136a-1136c (collectively referenced as 1136) as a task to be completed by the agent. The agent's workbin may be implemented via any data structure conventional in the art, such as, for example, a linked list, array, and/or the like. The workbin 1136 may be maintained, for example, in buffer memory of each agent device 1130.

According to one exemplary embodiment, the mass storage device(s) 1126 may store one or more databases relating to agent data (e.g. agent profiles, schedules, etc.), customer data (e.g. customer profiles and loyalty information), interaction data (e.g. details of each interaction with a customer, including reason for the interaction, disposition data, time on hold, handle time, etc.), and the like. According to one embodiment, some of the data (e.g. customer profile data) may be maintained in a customer relations management (CRM) database hosted in the mass storage device 1126 or elsewhere. The mass storage device may take form of a hard disk or disk array as is conventional in the art.

According to some embodiments, the contact center system may include a universal contact server (UCS) 1127, configured to retrieve information stored in the CRM database and direct information to be stored in the CRM database. The UCS 1127 may also be configured to facilitate maintaining a history of customers' preferences and interaction history, and to capture and store data regarding comments from agents, customer communication history, and the like.

The contact center system 1160 may also include a reporting server 1134 configured to generate reports from data aggregated by the statistics server 1132. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

In one embodiment, the contact center system 1160 further includes a hiring recommendation server 1160 for hosting, for example, the scheduler module 100, scorer module 114, and synchronization server 110 of FIG. 1 The contact center system 1160 may further include a performance monitoring server 1162 which may include the trainer module 120, performance monitoring module 116, and analysis server 112 of FIG. 1.

In one embodiment, each of the various servers, controllers, switches, gateways, engines, and/or modules (collectively referred to as servers) in the afore-described figures are implemented via hardware or firmware (e.g. ASIC) as will be appreciated by a person of skill in the art.

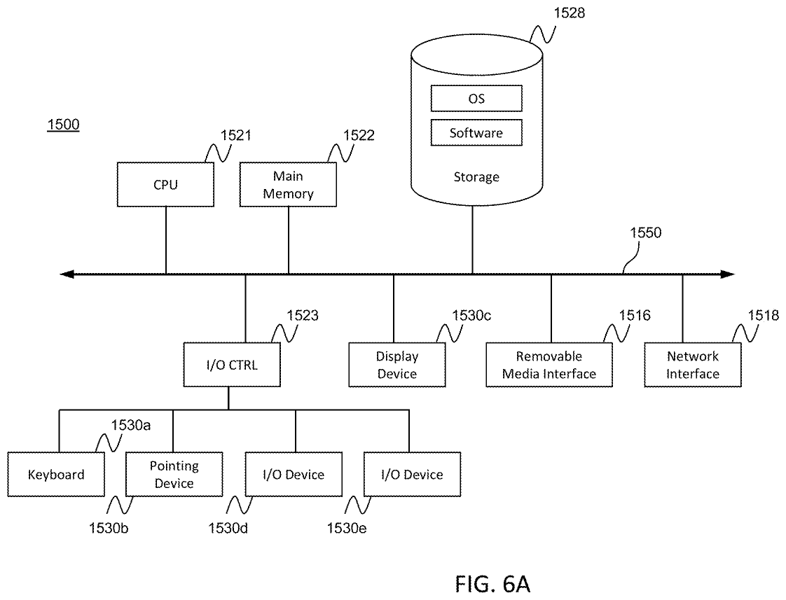

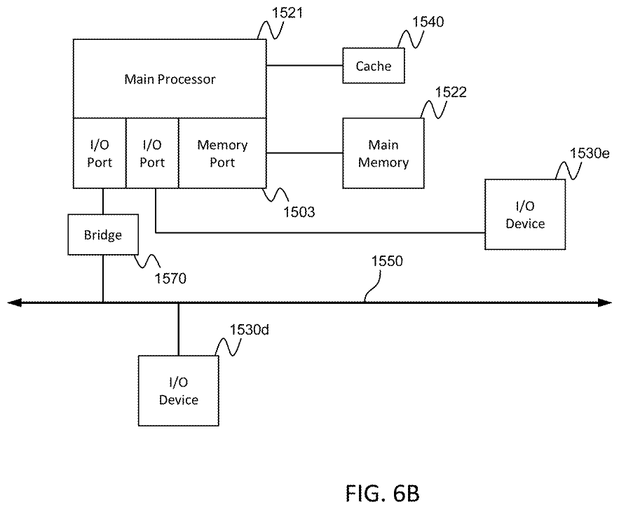

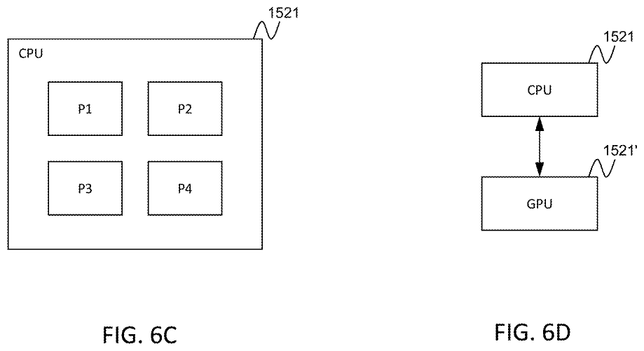

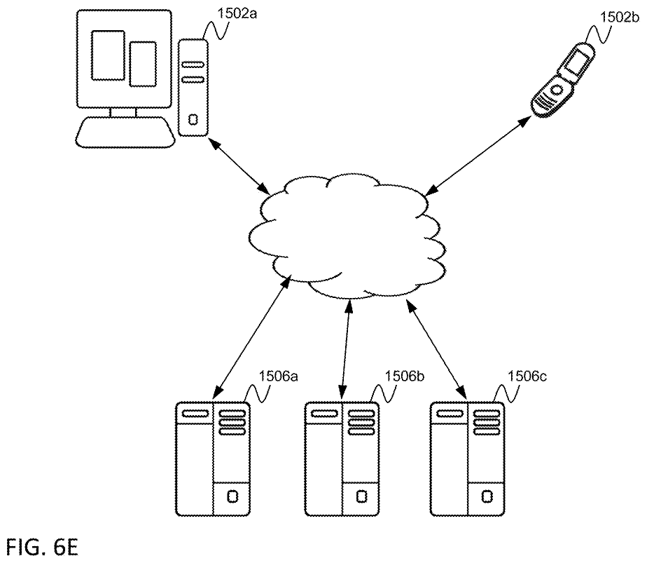

In one embodiment, each of the various servers, controllers, switches, gateways, engines, and/or modules (collectively referred to as servers) in the afore-described figures is a process or thread, running on one or more processors, in one or more computing devices 1500 (e.g., FIG. 6A, FIG. 6B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 6A and FIG. 6B depict block diagrams of a computing device 1500 as may be employed in exemplary embodiments. Each computing device 1500 includes a central processing unit 1521 and a main memory unit 1522. As shown in FIG. 6A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 6B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 6A, the central processing unit 1521 communicates with the main memory 1522 via a system bus 1550. As shown in FIG. 6B, the central processing unit 1521 may also communicate directly with the main memory 1522 via a memory port 1503.

FIG. 6B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 6A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 6B depicts an embodiment of a computer 1500 in which the central processing unit 1521 communicates directly with I/O device 1530e. FIG. 6B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 6A, may control the I/O devices. The I/O controller may control one or more I/O devices such as a keyboard 1530a and a pointing device 1530b, e.g., a mouse or optical pen.

Referring again to FIG. 6A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 6A and FIG. 6B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 6C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 6D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 6E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 6E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 6E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

Although this invention has been described in certain specific embodiments, those skilled in the art will have no difficulty devising variations to the described embodiments which in no way depart from the scope and spirit of the present invention. For example, instead of routing of a single interaction to a single agent in a sequential manner, the embodiments could be extended to concurrent routing/assignment of multiple interactions to multiple agents. Furthermore, to those skilled in the various arts, the invention itself herein will suggest solutions to other tasks and adaptations for other applications. For example, although the above embodiments have mainly been described in terms of routing inbound interactions, a person of skill in the art should appreciate that the embodiments may also be applied during an outbound campaign to select outbound calls/customers to which an agent is to be assigned. Thus, for example, the reward maximization module 102 may rate customers based on their profiles and assign a specific agent to one of the calls/customers that is expected to maximize a reward (e.g. sales). Thus, the present embodiments of the invention should be considered in all respects as illustrative and not restrictive.

1. A method for predicting performance for a contact center via machine learning, the method comprising:
invoking, by a processor, an interaction between a contact center resource and an end user;
recording, by the processor, the interaction;
automatically analyzing, by the processor, the recorded interaction for identifying attributes associated with the interaction;
providing, by the processor, the identified attributes to a machine learning model;
predicting, by the processor, a performance score based on providing the identified attributes to the machine learning model;
comparing the performance score against a threshold score; and
outputting, by the processor, a recommendation based on the comparing.

2. The method of claim 1, wherein the interaction is a simulated call between the end user and a voice processor of the contact center, wherein the voice processor is configured with a script for conducting the simulated call.

3. The method of claim 1, wherein the attributes include emotions of the end user during the interaction, adherence of the end user to a script invoked for the interaction, or clarity in speech of the end user during the interaction.

4. The method of claim 1, wherein the automatically analyzing of the recorded interaction includes assigning a score to each of the identified attributes.

5. The method of claim 1, wherein the predicted performance score is for predicting performance of the end user in meeting particular metrics for the contact center.

6. The method of claim 1 further comprising:
monitoring contact center agents of the contact center;
gathering performance scores of the monitored contact center agents;
invoking a second interaction with the contact center agents;
obtaining attribute scores for the contact center agents based on the second interaction;
correlating the attribute scores with the performance scores; and
training the machine learning model based on the correlation.

7. The method of claim 1 further comprising:
monitoring a criteria of the contact center; and
dynamically adjusting the threshold based on the monitored criteria.

8. The method of claim 1, wherein the end user is a candidate contact center agent considered for hiring, and the recommendation is hiring the candidate or advancing the candidate to a next step of an interview process.

9. A system for predicting performance for a contact center via machine learning, the system comprising:
processor; and
memory, wherein the memory has stored therein instructions that, when executed by the processor, cause the processor to:
invoke an interaction between a contact center resource and an end user;
record the interaction;
automatically analyze the recorded interaction for identifying attributes associated with the interaction;
provide the identified attributes to a machine learning model;
predict a performance score based on providing the identified attributes to the machine learning model;
compare the performance score against a threshold score; and
output a recommendation based on the comparing.

10. The system of claim 9, wherein the interaction is a simulated call between the end user and a voice processor of the contact center, wherein the voice processor is configured with a script for conducting the simulated call.

11. The system of claim 9, wherein the attributes include emotions of the end user during the interaction, adherence of the end user to a script invoked for the interaction, or clarity in speech of the end user during the interaction.

12. The system of claim 9, wherein the instructions that cause the processor to automatically analyze the recorded interaction include instructions that cause the processor to assign a score to each of the identified attributes.

13. The system of claim 9, wherein the predicted performance score is for predicting performance of the end user in meeting particular metrics for the contact center.

14. The system of claim 9, wherein the instructions further cause the processor to:
monitor contact center agents of the contact center;
gather performance scores of the monitored contact center agents;
invoke a second interaction with the contact center agents;
obtain attribute scores for the contact center agents based on the second interaction;
correlate the attribute scores with the performance scores; and
train the machine learning model based on the correlation.

15. The system of claim 9, wherein the instructions further cause the processor to:
monitor a criteria of the contact center; and
dynamically adjust the threshold based on the monitored criteria.

16. The system of claim 9, wherein the end user is a candidate contact center agent considered for hiring, and the recommendation is hiring the candidate or advancing the candidate to a next step of an interview process.
